(19) United States
(12) Patent Application Publication
(10) Pub. No.: US 2017/0249926 A1
(43) Pub. Date: Aug. 31, 2017

(54) Efficient Acoustic Enhancement of End pins and receptacles for stringed musical instruments and the like using customized filler materials

(71) Applicant: Thomas J. DeVuono, Louisville, KY (US)

(72) Inventor: Thomas J. DeVuono, Louisville, KY (US)

(21) Appl. No.: 15/056,943

(22) Filed: Feb. 29, 2016

(51) Int. Cl. G10D 3/00; H04R 1/08; H04R 1/02

(52) U.S. Cl. CPC G10D 3/003; H04R 1/026; H04R 1/08

(57) ABSTRACT

The invention presented herein allows efficient modification of endpins for musical instruments such as cello or bass that use cavities in one or more components that accommodate filler material. The filler materials are composed of materials that affect the acoustic outcomes. The user can modify the endpin acoustic outcomes relatively quickly by changing the filler composition until a desired acoustic outcome is achieved. This allows various acoustic outcomes using the same shape, materials, and construction for the endpin components. Several embodiments are illustrated for endpins, pedestals, stringed instrument sound posts, interior blocks, bass bars, speaker legs and the like.

### STATEMENT REGARDING FEDERALLY SPONSORED RESEARCH OR DEVELOPMENT

Not Applicable.

### REFERENCE TO SEQUENCE LISTING, TABLE, OR A COMPUTER PROGRAM LISTING

Not Applicable.

### COMPACT DISK APPENDIX

Not Applicable

### BACKGROUND OF THE DISCLOSURE

There are many patent documents and commercial products describing tail pieces, endpins, and end piece receptacles for stringed musical instruments such as a cello, bass or the like. The approach often taken specifies the specific shapes and materials defining the structure of the endpins and receptacles. Arguments are then made as to why these designs will give a desired performance related to timber, loudness, and tone. Examples of the patent documents are U.S. Pat. No. 6,127,611 by VanEvers, U.S. Pat. No.4,018,129 by Hollander, US2006/01278059 by Gipson. DeVuono's prior art patent, U.S. Pat. Nos. 6,998,523, and D658,1625 are included in these documents. However, there does not exist a general approach to quickly modify the design to customize the acoustic outcomes of these designs. Therefore, there is a need for a design approach that allows the user to quickly make modifications to the device to achieve a favorable acoustic outcome.

### SUMMARY OF THE DISCLOSURE

The invention presented herein solves the problem of provided endpins, end piece receptacles, and the like for musical instruments such as a cello or bass that are constructed using cavities in one or more components that accommodate filler materials. The filler materials are composed of materials that intend to enhance the acoustic outcomes. Endpin's acoustic outcomes may be modified relatively quickly by changing the filler material composition until a preferred acoustic outcome is achieved. This allows various acoustic outcomes using the same shape, materials, and construction of the endpin components.

In a first embodiment, an endpin is constructed from an elongated hollow rod secured at its first and second ends with set screws. Contained in the rod is filler material that is selected to control the acoustic outcome of the instrument. Attached to rod first end is a curved stopper with stopper first internal threads located on stopper first end that screws into external threads located on the rod first end. Stopper second end is attached to a tip having a tip body and tip screw. The stopper second end has second internal threads that attach tip to stopper with male tip screw Other embodiments are included, including application of the inventive concept for receptacles and string instrument interiors.

### BRIEF DESCRIPTION OF THE DRAWINGS

FIG. 1 illustrates a first embodiment of an endpin of the current invention.

FIG. 1a illustrates the first embodiment being used with a musical instrument

FIG. 2 presents an exploded view of FIG. 1.

FIG. 3 illustrates a sectional view of the first embodiment.

FIG. 3a illustrates a portion of FIG. 3 in an expanded scale.

FIG. 4 illustrates the pointed tip of FIG. 3 in an expanded scale.

FIG. 5 illustrates an exploded view of a second embodiment of the current invention.

FIG. 6 is a sectional view of FIG. 5.

FIG. 7 illustrates a portion of FIG. 6 in an expanded scale.

FIGS. 8 a perspective view of an end piece receptacle comprising a third embodiment of the present invention.

FIG. 9 illustrates a sectional view of the tip component of the third embodiment.

FIG. 10 is an exploded perspective view of FIG. 8.

FIG. 11 illustrates a sectional view of a leg component of the third embodiment

FIG. 12 illustrates a perspective view of a fourth embodiment comprising an endpin.

FIGS. 13a through 13c illustrate 3 versions of locking nuts of the fourth embodiment of the current invention.

FIGS. 14 and 15 illustrate a perspective view and a sectional view respectively of the stopper and tip of the fourth embodiment of the current invention.

FIG. 16 illustrates an exploded view of a cello body of the fifth embodiment of the current invention.

FIGS. 17, 18u and 18l are three sectional views of FIG. 16 illustrating the sound post, upper support block and lower support block of the fifth embodiment of the current invention.

FIG. 19 illustrates a cross section of the bass bar of the fifth embodiment of the current invention

FIG. 20 illustrates four legs of the sixth embodiment used to support a speaker.

FIG. 21 illustrates one of the legs used to support a speaker of the sixth embodiment of the current invention.

FIG. 22 is a sectional view of FIG. 21.

### DETAILED DESCRIPTION

Directional terms such as “front”, “back”, “in”, “out”, “downward”, “upper”, “lower”, and the like may be used in the description. These terms are applicable to the embodiments shown and described in conjunction with the drawings. These terms are merely used for the purpose of description in connection with the drawings. The term musical instrument is understood in a general sense to include typical musical instruments such as a cello or bass, and other devices used to produce musical sounds such as speakers and pianos. The term acoustic device refers to endpins, tailpieces, legs, posts or other devices used with a musical instrument to enhance the acoustic outcome.

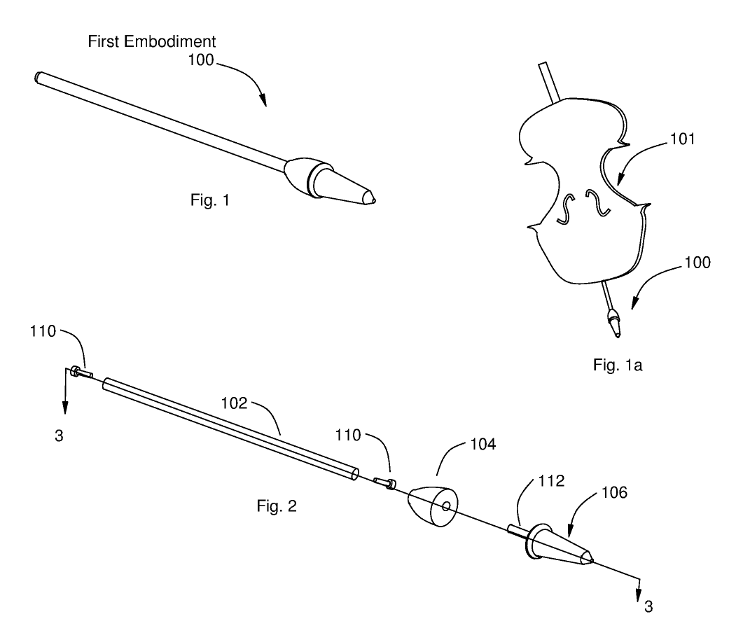

FIG. 1 shows an endpin of the first embodiment 100 of the present invention. FIG. 1a illustrates the first embodiment 100 being used with a musical instrument 101. FIG. 2 illustrates first embodiment 100 in an exploded view. The endpin is constructed from a rod 102, a stopper 104 having two set screws 110, and a pointed tip 106 having a tip screw 112.

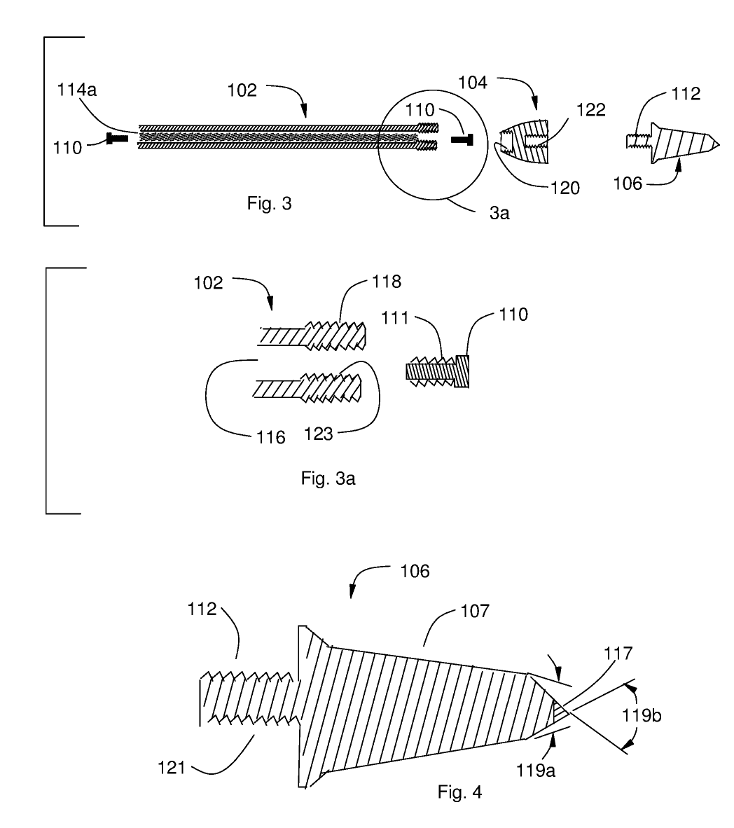

FIG. 3 illustrates a cross sectional view of FIG. 2 with filler material 114a. FIG. 3a illustrates a portion of FIG. 3 in an expanded scale, shown without the filler material. Referring to FIGS. 3 and 3a, rod 102 has a shaft 116 drilled through the length of its interior and filled with a filler material 114a. Two set screws 110 have first male threads 111 that are matched to first female threads 123 located on the ends of shaft 116 that are used to removably seal the shaft 116 after filler material 114a is packed into the shaft. Rod 102 additionally has second male threads 118 that are matched to second female threads 120 located on left of stopper 104. In alternate embodiments, the set screws may be replaced by other mechanisms for removably sealing the shaft 116, such as rubber plugs, corks, and metal stoppers.

Stopper 104, shaped as shown in FIGS. 3, 3a and 4, has third female threads 122 located on right end of stopper that are matched to third male threads 121 located on left end on tip screw 112 emanating from pointed tip 106 as shown. Stopper 104 may be made of the same material as tip body 107 or from a different material and jointed to tip body.

FIG. 4 is a cross-Section of pointed tip 106. It is composed of tip screw 112, tip body 107 and tip point 117. Tip point 117 has a tip body angle 119a and tip point angle 119b. For the first embodiment of a tip body angle 119a is 21 degrees and tip point angle 119b of 63 degrees. Alternate embodiments of the first embodiment may have different angles, depending on size material and instrument.

The left end of rod 102 fits into the instrument body. It can come in various lengths, and may additionally have an adapter to match the rod to the orifice on the instrument that it is attached to. The remaining components of first embodiment 100 are of greater mass. This makes the vibration move in that direction towards the tip and then to the ground.

The rod 102 of the first embodiment is made of brass. Rods of the first embodiment have various sizes, depending on the application. Typical sizes are an outside diameter of 7 mm (0.276 in), 8 mm (0.315 in), 10 mm (0.394 in), 12.7 mm (0.500 in) or custom cut larger for some acoustic bass instruments. Alternate embodiments have an outside diameter up to 16.5 mm (0.650 in). Rod length can range between 20 cm (8 in) and 61 cm (24 in) and is cut to suit the instrument and end user preferred play angle and position. The shaft 116 is drilled through rod 102 and has 4 mm (0.157 in) shaft on 8 mm (0.315 in) rods and/or a 6.35 mm (0.250 in) shaft on the larger haft on the larger diameter rods centered along the longitudinal axis. This shaft 116 in alternate embodiments may be larger or smaller depending on the choice of material and/or size.

The pointed tip 106 has tip body 107 of brass, and the top point tip is made of tungsten and brazed to the tip body 107. The dimensions of the rod are given above. Stopper/dome in this embodiment has a height of 0.375 in (9.54 mm) with a 0.875 in ((22.2 mm) diameter decreasing to a diameter of 0.625 in (15.8 mm) diameter. The tip is 1.5 in (38.07 mm) long with two primary angles. The dimensions of the stopper/dome in alternate embodiments may vary from these dimensions depending on size, materials and instrument.

The pointed tip 106 is unique in the ratios used and the way the brass is drilled and the tungsten is brazed. The pointed tip 106 is user replaceable if there is an upgrade or if it is damaged, or could be replaced with the ball tip 302 (see third embodiment 300 discussed below).

The first embodiment was originally used by the Inventor without the filler material 114a with excellent acoustic results for a particular cello. However, when applied to other string instruments, the results were less satisfactory. Favorable acoustic outcomes were therefore achieved by varying the filler material 114a by trial and error. The filler material 114a used include various pellets or powdered materials depending on the acoustic properties desired. Examples of filler material are given in Table 1, together with their acoustic properties.

TABLE 1
Filler Materials and their Properties

| | Filler Materials | Acoustic Properties |
|---|---|---|
| 1 | s70 steel shot | helps control resonance of the base material |
| 2 | s110 steel shot | same resonance control better greater |
| | | frequency extension |
| 3 | s70 and s110 | More frequency extension than s70 steel |
| | steel shot blend. | shot less than s110 |
| 4 | Bronze shot | overdamped sound and over control of |
| | | natural resonance of instrument. |
| 5 | Bronze powder | extremely damped sound |
| 6 | s110 steel shot | control and extension of sound |
| | and neodymium | |
| | powder blend | |
| 7 | S110 steel shot, | Control and extension of frequency extremes |
| | neodymium | with greater focus and detail of individual |
| | powder and | notes |
| | magnetic pellets | |
| 8 | Copper powder | Warmer tone with frequency extension and |
| | or pellets | detail yet maintains focus and detail of |
| | neodymium | individual notes. |
| | powder and | |
| | magnetic pellets | |

The Inventor has particular success with acoustic outcome by using magnetic pellets and powders added to the filler material. The magnetic pellets and powders have the acoustic characteristics of providing more coherent and focused sound that makes the instrument more reactive and responsive to input.

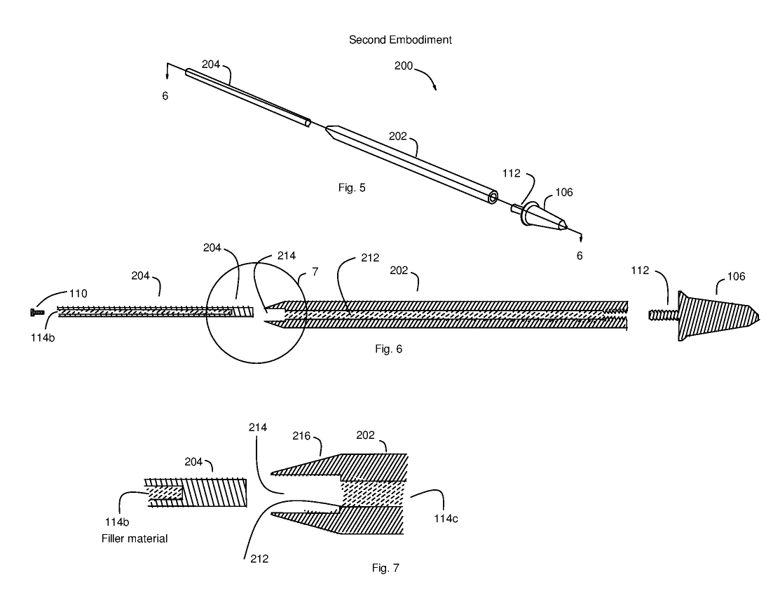

FIGS. 5 through 7 illustrate a second embodiment 200 of the current invention. Only the differences between the first and second embodiments are discussed here in detail. The second embodiment 200 has a rod 202, a pointed tip 106 a stem 204, and has filler material 114b. Stem 204 fits into the left end of rod 202. Stem 204 has a second shaft 212 that is drilled on the left end of stem 204, containing filler material 114c. The right end of stem 204 is matched to a cavity 214 located on rod left end 216; cavity 214 has a slightly larger diameter than second shaft 212 located along the remaining longitudinal axis of rod 202. The rod left end 216 is tapered as shown. Stem 204 have typical diameters of 7 mm (0.28 in) for bass clarinet, 8 mm (0.315 in) or 10 mm (0.394 in) for cello or bass, and 12.7 mm (0.5 in) for special applications. Some specialty rods can be larger. Rod 202 typically has diameter between 15.875 mm (0.625 in) and 22.225 mm (0.875 in).

An s70/s110 steel pellet blend was used for filler materials 114b and 114c. Also used was a 110/neodymium magnetic in a first prototype for the second embodiment and had the same material as filler material 114a. However, modifications to the filler material were made iteratively by trial and error. Excellent results were obtained for s110 steel shot and neodymium magnetic powder blend with magnetic pellets added.

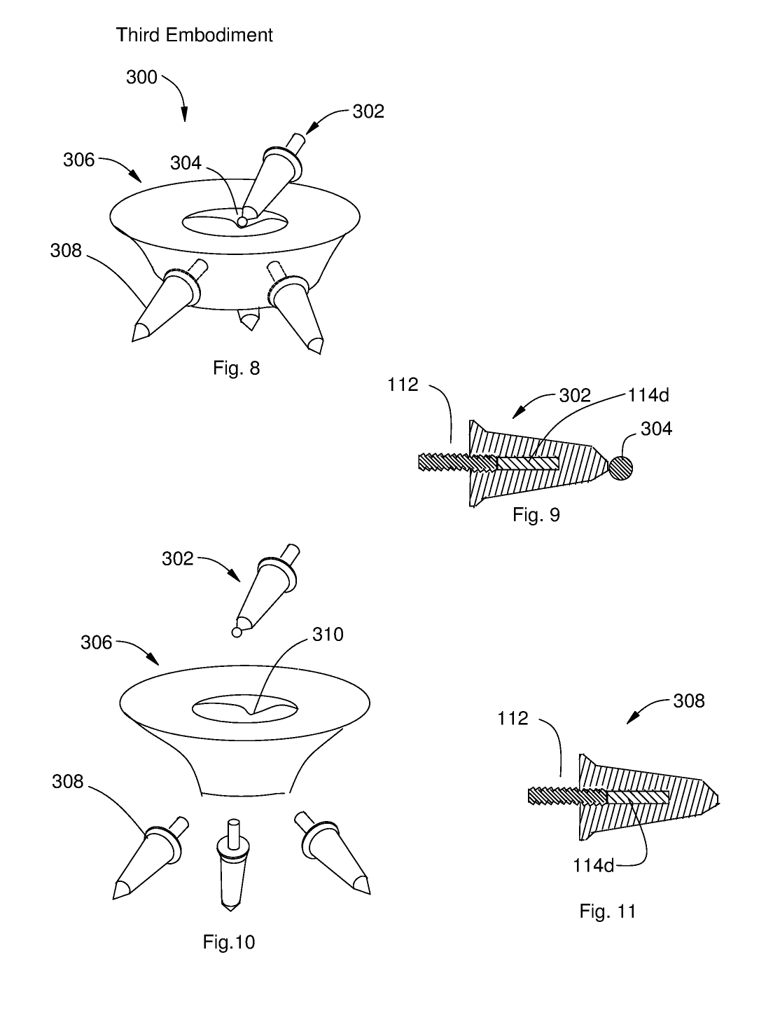

FIGS. 8 through 11 illustrate a third embodiment 300 of the present invention, which is a modification of the Inventor's D658,1625S design patent. Third embodiment 300 replaces the pointed tip 106 of embodiment 2 by a ball tip 302 and pedestal 306. The ball tip 302 has a sphere 304 attached to its end. Referring to FIGS. 8, 9 and 11, third embodiment 300 has pedestal 306 with a depression 310 that accommodate the sphere 304 that allows ball tip 302 to rotate freely within it. Additionally, third embodiment 300 has three legs 308 that attach to pedestal 306. In the third embodiment, the three legs 308 have the properties of pointed tip 106 of the first embodiment, although other types of legs, or the absence of legs, are also consistent with the inventive concept. Sphere 304 of ball tip 302 has radius 0.075 inches, and the pedestal, made of brass, three inch across legged bottom and 4 inches across the top.

FIG. 9 is a sectional view of ball tip 302, and FIG. 11 is a sectional view of leg 308. Both ball tip 302 and legs 308 use filler material 114d. The filler material 114a used in the first embodiment was used here also. In an alternate to the third embodiment, filler material used was s110 neodymium magnetic powder.

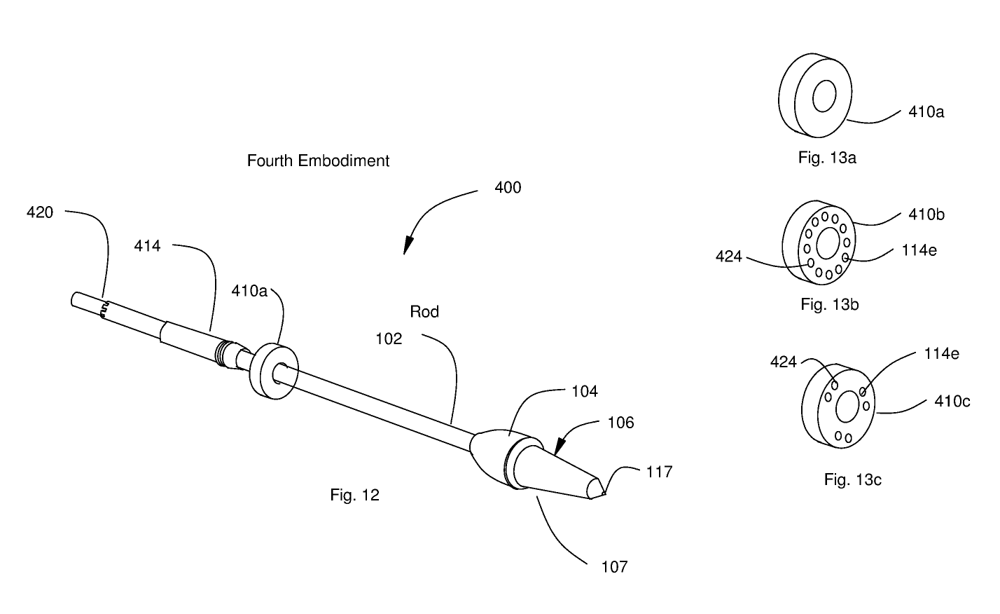

FIG. 12 illustrates a fourth embodiment 400. This embodiment has a locking collet nut 410a that attaches and secures a tapered collet body 414 with a castle 420 at left end of the rod 102. The feature, like that of a castle 420, reduces standing wave resonance. Instead of one large smooth area that would generate one large resonance peak, the castle 420 breaks what could be one large single resonance into several smaller and separated peaks or nodes that will not overlap nor add to each other by becoming a single resonance peak. Several smaller resonances are less audible than one large dominating resonance peak

FIG. 13a illustrates locking collet nut 410a. Alternate embodiments to locking collet nut 410a illustrated in FIGS. 13b and 13c which has twelve bores (FIGS. 13b) or six bores (FIG. 13c). The reaction of the fourth embodiment with the use of any of the three locking collet nuts 410a through 410c will be apparent and have a different resonance character depending on which collet nut is used. These resonance characteristics will also be different on different instruments and the choice which to use will be the preference of the musician or designer.

Referring to FIGS. 12 through 13c, rod 102 is inserted into tapered collet body 414 and secured and clamped with a locking collet nut 410. Second collet nut 410b has twelve bores 424 drilled to reduce mass when compared to locking collet nut 410a or hybrid collet nut 410c medium mass lock nut. Second collet nut 410bhas filler material 114e added to four of the twelve bores. These four bores are then sealed to retain the fill material. (Details of the seals and filler are not shown in FIGS. 410b and 410c). The end user has a choice of what reactive material mass with the substitution of any of the locking collet nuts 410a through 410c. Variations of bores 424 may be made by the designer.

The fact that these areas of the castle 420 are cut around the circumference of the tapered collet means the spacing is not at a predictable repeatable pattern. These irregular cut facets and varied geometric shapes of the castle 420 will also help generate more diverse acoustic patterns and angles of pressure moving off the surface of the tapered collet and onto the radiating wood surface of the instrument. The castle 420 provides the additional performance advantage over the prior art.

The tapered collet body 414 is threaded into the instrument so it does not move as the wooden instrument changes with temperature and humidity. This was introduced by Klaus Bender. However, unlike the Bender and others, the tapered collet body 414 which for this example is used in a cello has a length of 63.5 mm (2.5 in) and extends well past the usual wooden support block of a cello. The support block is typically 1 to 1.5 inches in thickness/height and is internal to a cello. For viola or violin or any other string instrument that may use a button or endpin plug the scale and length inside the instrument can be recalculated to suit a particular instrument and yet extend well past the wooden support block of that chosen instrument. The purpose of this extra length is to increase the effective radiated acoustic collection area within the instrument body. Other designs rely solely on energy transmission thru the typical wooden block and do not collect airborne energy from within the instrument cavity. The benefit is that the instrument will radiate more energy through its external surface, an enhancement for both player and audience. The entire surface of the tapered collet has threads (threads not illustrated in the drawings). The threaded area above the wooden block is again an acoustic benefit. The threads actually increase the surface area of the taper and allow for the capture of more acoustic energy and sound pressure. This is preferable to a smooth extended surface which has less surface area than the same circumference and length. A smooth tapered body could be used, but threaded is preferred. These same threads, because they are at a tapered ratio and angle along the circumference of the tapered body capture frequencies that will not overlap and would serve to reinforce each other. This way is better because no single frequency will overlay another. Hence, no single frequency can dominate another.

Interchanging the locking collet nuts 410a through 410c causes a change in resonance and tone within the instrument, cello or bass. Another benefit of this feature is that it changes the string response of the instrument both in the free hand or with the bow. This reactive variability is at the choice of the player and their preference in playability and resonance response.

Referring to FIGS. 12, 14 and 15, rod 102 in this rendition is 0.500 inches in diameter. This rod is brass or an alloy but could be carbon fiber, or bronze or a bronze alloy, or aluminum or an aluminum alloy. Rod 102 in this fourth embodiment is hollow and then filled with filler material 114f. Each end of the rod 102 is sealed with one of the two set screws 110 to seal in this material. One end of 102 is threaded on its outside diameter to accept stopper 104. Stopper 104 is shaped and fitted to the rod 102 so vibrational energy and resonance is directed to the tip screw 112 attached to tip body 107 which contacts a higher mass surface, such as a stage floor. Tip body 107 has a tungsten cobalt insert that is sharp and strong to secure to most any wooden surface without the use of any other device to stop the instrument or device from slipping.

Referring to FIG. 15, filler material 114f is imbedded in shaft 116 positioned in rod 102 can be used to further modify the resonance and tone. While the metallic components in the fourth embodiment 400 are designed to give an initial resonance and tone that the designer wants to achieve, further enhancements to the sound may be made by adjusting the filler material 114f in the rod 102. In addition, the filler material 114e located in the bores 424 in the locking collet nuts 410 further allow minor adjustments to the resonance and tone.

The actual material used for the filler was determined by trial and error for the fourth embodiment. The filler material described in the previous embodiments may be used. The Inventor has had good success using ferrous bearing neodymium magnetic powder and magnetic spheres for this embodiment.

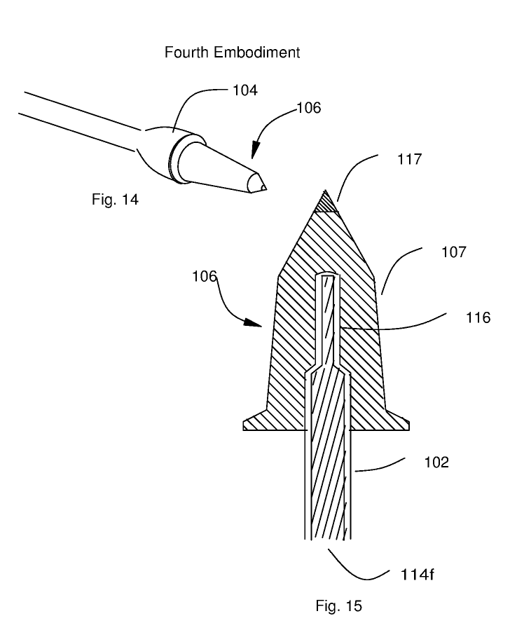

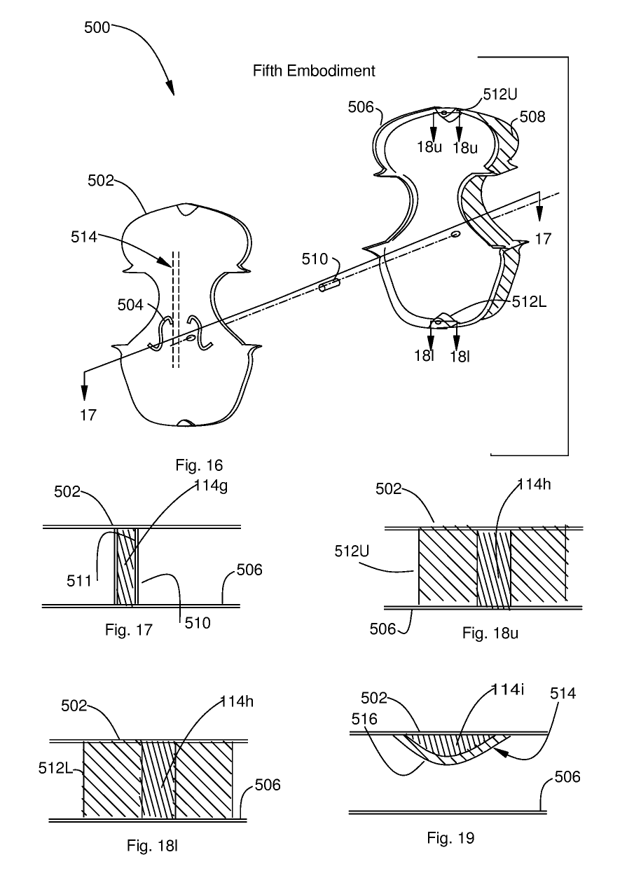

FIG. 16 illustrates an exploded perspective view of a fifth embodiment 500 of the current invention. Illustrated is the cello body top part 502 with two f slots 504 cello body back part 506 and cello body sides 508. Also shown is a sound post 510 which is a solid wood cylinder that contains filler material 114g that transverses from the cello body top part 502 to the cello body back part 506, perpendicular to the planes of the cello body top part 502 and cello body back part 506. Also shown are an upper support block 512U and lower support block 512L containing filler material 114h. Also shown is the bass bar 514 having wood strip 516 containing filler material 114i as shown.

FIG. 17 illustrates a sectional view in an expanded scale of a portion of the cello with sound post 510 containing filler material 114g. FIGS. 18u and 181 illustrate sectional views of the upper and lower support blocks 512U and 512L containing filler material 114h. The filler material 114g and 114h in the fifth embodiment 500 are the same filler materials in the first embodiment.

FIG. 19 illustrates a sectional view of the bass bar 514 containing filler material 114i. Although not shown in the figures, the top and bottom ends of the bass bar 514 are sealed to prevent the filler material 114i from leaking.

Although the filler material described in the five embodiments and their alternate embodiments apply to string instruments and their accessories, the same concept applies to other devices that have acoustic outcomes such as the legs or support systems of any instrument that touches the floor boundary. These may include keyboard instruments percussion instruments.

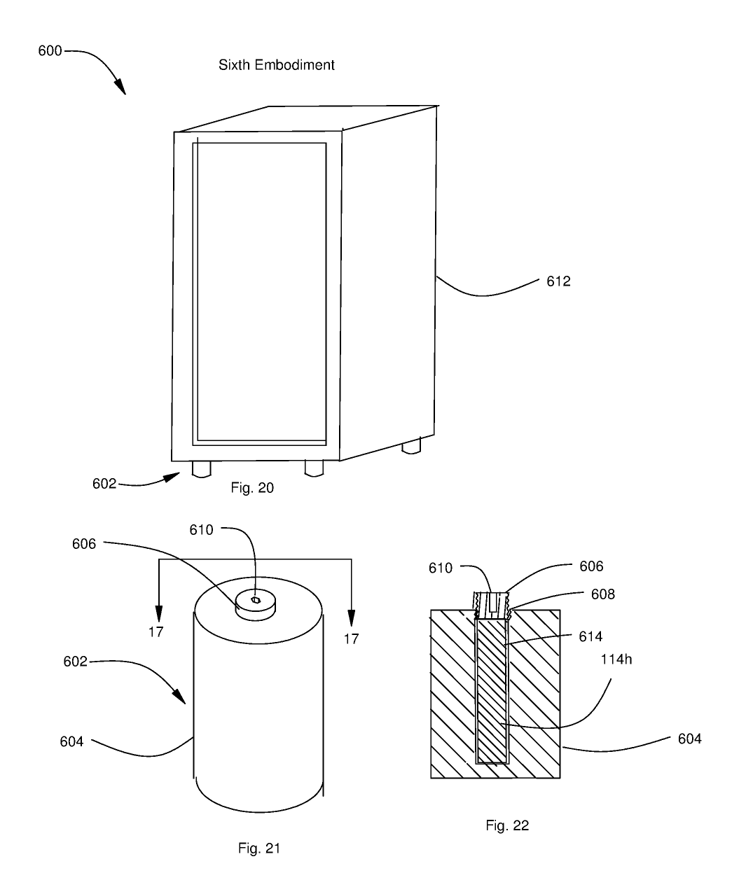

FIG. 20 illustrates a sixth embodiment 600 of the current invention, which consists of four feet 602, attached to a speaker 612. The speaker is not part of the embodiment. FIG. 21 is a perspective view of a foot 602. The four feet 602 are used to support the speaker 612. FIG. 22 is a sectional view of FIG. 21. Each foot 602 is constructed out of a solid cylinder 604 that has a cylindrical hole 614 located in the solid cylinder's interior along the vertical axis of solid cylinder 604. Cylindrical hole 614 is removably sealed with a cylindrical plug 606 that may be inserted in cylindrical hole 614 at the top using matching threads 608. Male component of threads 608 located on cylindrical plug 606 are used to be removably secured to female threads located in bottom of speaker 612 (female threads not shown). A hexagon shaped socket 610 is located on top center of cylindrical plug 606 is used to removably attach cylindrical plug 606 in cylindrical hole 614. The cylindrical hole 614 accommodates filler material 114h. Alternate embodiments of the sixth embodiments could have a different number of legs, and apply to the legs of other musical instruments such as, but not limited to, pianos and sound stages, electronic equipment, and microphone stands.

The disclosure presented herein gives six embodiments of the invention. These embodiments are to be considered as only illustrative of the invention and not a limitation of the scope of the invention. Various permutations, combinations, variations and extensions of these embodiments are considered to fall within the scope of this invention. Therefore, the scope of this invention should be determined with reference to the claims and not just by the embodiments presented herein.

What is claimed:

1. An acoustic device, said acoustic device configured to be used with a musical instrument,
said acoustic device having at least one shaft containing filler material;
said filler material is selected from the group consisting of shots, pellets, powders, magnetic material and a combination thereof;
said filler material being configured to customize acoustic outcome of said musical instrument when said musical instrument is used with said acoustic device.

2. The acoustic device of claim 1 wherein said acoustic device having a mechanism for removably sealing said at least one shaft, said mechanism configured to replacing said filler material installed in said at least one shaft with a different filler material.

3. The acoustic device of claim 2 wherein said musical instrument is a stringed musical instrument selected from the group consisting of a cello, bass, violin, viola, and guitar.

4. The acoustic device of claim 2 wherein said filler material are selected from the group consisting of s70 steel shot, s110 steel shot, bronze shot, bronze powder, neodymium powder, magnetic spheres, magnetic pellets and a combination thereof.

5. The acoustic device of claim 2 is comprised of
a rod, said rod having a rod first end and a rod second end;
a first shaft positioned along longitudinal direction of said rod, said first shaft extending through interior of said rod, said first shaft adapted to being filled with said filler material;
said rod being adapted to removably seal to said first shaft after said filler material is inserted into said first shaft;
a stopper; said stopper having a stopper first end and a stopper second end; said stopper being adapted to attach to said rod at said rod second end, said rod being adapted to attach to said musical instrument at said rod first end.

6. The acoustic device of claim 5 further comprising a pointed tip, said pointed tip attachable to said stopper at said stopper second end, said pointed tip comprised of a tip body and a tip point.

7. The acoustic device of claim 6 wherein said rod is made of brass having an outside diameter between 0.276 in, and 0.650 in, said rod having a length between 8 in and 24 in, and is sized to accommodate end user preferences, said first shaft has dimension between 0.157 in and 0.250 in.

8. The acoustic device of claim 6 wherein said tip body being comprised out of brass, and said pointed tip is made of tungsten and brazed to the tip body; said stopper has a height to 0.375 in with a 0.875 in diameter decreasing to diameter of 0.625 in diameter; said tip body being 1.5 in long.

9. An acoustic device, said acoustic device configured to be-used with a musical instrument,
said acoustic device having at least one shaft containing filler material;
said filler material is selected from the group consisting of shots, pellets, powders, magnetic material and a combination thereof;
and wherein said acoustic device having a mechanism for removably sealing said at least one shaft configured to accommodate replacing said filler material installed in said at least one shaft with a different filler material;
said acoustic device being further comprised of
a rod, said rod having a rod first end and a rod second end;
a first shaft positioned along longitudinal direction of said rod, said first shaft extending through interior of said rod, said first shaft configured to being filled with said filler material;
said rod being configured to removably seal to said first shaft after said filler material is inserted into said first shaft;
a stopper; said stopper having a stopper first end and a stopper second end; said stopper being configured to attach to said rod at said rod second end, said rod being configured to attach to said musical instrument at said rod first end,
said acoustic device being further comprised of a pointed tip, said pointed tip attachable to said stopper at said stopper second end, said pointed tip comprised of a tip body and a tip point;
said acoustic device additionally has a stem, said stem having a stem first end and a stem second end, said stem attachable to said rod first end, said stem has a second shaft starting at said stem first end and terminating prior to said stem second end; said second shaft being configured to contain said filler material; said stem second end being matched to a cavity located on said rod first end; said stem second end being removably attachable to said cavity.

10. The acoustic device of claim 9 further comprising a locking collet nut that attaches and secures a tapered collet body with a castle to said rod at said rod first end, said tapered collet body being removably attachable to said musical instrument
wherein taper of said tapered collet body reduces standing wave resonance by the tapered collet body and additionally by irregular facets of the castle, and said tapered collet body generates more and varied acoustic pressure within the musical instrument, and said castle with its varied facets of shapes and sizes of the tapered collet body additionally allows for collection and generation of more varied acoustic resonance within said musical instrument.

11. The acoustic device of claim 10 wherein said locking collet nut has a plurality of bores positioned on said locking collet nut.

12. The acoustic device of claim 11 wherein said plurality of bores of said locking collet nut has said filler material added to at least one of said plurality of bores, said least one of said plurality of bores being removably sealable to retain said filler material wherein said plurality of bores and said filler material being selected so that said plurality of bores and said filler material provide a variety of resonance characteristic.

13. An acoustic device, said acoustic device being used with a musical instrument, said acoustic device comprised of a pedestal having a depression, said pedestal additionally having a plurality of legs emanating from bottom of said pedestal, each of said plurality of legs being removably attachable to said pedestal, each of said plurality of legs having a shaft that accommodates filler material;
said filler material is selected from the group consisting of shots, pellets, powders, magnetic material and a combination thereof;
said filler material is configured to customize acoustic outcome of said musical instrument when said acoustic device is used with said musical instrument.

14. The acoustic device of claim 13, additionally comprised of a ball tip, said ball tip having a sphere attached to its lower end, said depression being able to accommodate said sphere that allows said ball tip to rotate freely within it, said ball tip being removably attachable to bottom of said musical instrument.

15. The acoustic device of claim 1, said acoustic device being used with a stringed musical instrument having a body top part, a body bottom part, an inside top part and an inside bottom part, said acoustic device comprised of a sound post, said sound post being comprised of a solid material that contain a third shaft, said third shaft transverses from said body top part to said body bottom part, said third shaft being orthogonal to planes of the body top part and body back part.

16. (canceled)

17. The acoustic device of claim 15 additionally comprised of at least one of an upper support bloc containing said filler material, a lower support block containing said filler material, and a bass bar containing said filler material.

18. (canceled)

19. (canceled)

20. (canceled)

21. Filler material, said filler material configured to be used in at least one shaft of a musical instrument,
said filler material being selected from the group consisting of shots, pellets, powders, magnetic material and a combination thereof;
said filler material being configured to customize acoustic outcome of said musical instrument when said filler material is inserted in at least one shaft of said musical instrument.

22. The filler material of claim 12 wherein said filler material are selected from the group consisting of s70 steel shot, s110 steel shot, bronze shot, bronze powder, neodymium powder, magnetic spheres, magnetic pellets and a combination thereof.
